(19) United States
(12) Patent Application Publication
(10) Pub. No.: US 2026/0274181 A1
(43) Pub. Date: Sep. 17, 2026

(54) WIRE HARNESS

(71) Applicant: Sumitomo Wiring Systems, Ltd., Yokkaichi-shi (JP)

(72) Inventor: Yuhei KOYAMA, Yokkaichi-shi (JP)

(73) Assignee: Sumitomo Wiring Systems, Ltd., Yokkaichi-shi (JP)

(21) Appl. No.: 19/560,906

(22) Filed: Mar. 9, 2026

(30) Foreign Application Priority Data
Mar. 12, 2025 (JP) 2025-039512

(51) Int. Cl. B60R 16/02; H02G 3/04; H02G 3/06

(52) U.S. Cl. CPC B60R 16/0222; H02G 3/0468; H02G 3/0658

(57) ABSTRACT

A wire harness that includes: a tubular shield shell that is configured to cover an outer circumferential surface of a connector housing; a tubular braided wire that is configured to cover an outer circumferential surface of an electric wire extending from the connector housing; a fixing ring that fixes the braided wire to an outer circumferential surface of the shield shell; a tubular grommet that covers the shield shell, the braided wire, and the fixing ring; and a protective tube that is formed of a flexible material and that covers an outer circumferential surface of the fixing ring inside the grommet.

### BACKGROUND

The present disclosure relates to a wire harness.

Conventionally, a wire harness for a vehicle includes a tubular shield shell that covers an outer circumferential surface of a connector housing, and a tubular grommet that covers the shield shell (see JP 2018-121467A, for example). In such a wire harness, a tubular braided wire that covers an outer circumferential surface of an electric wire extending from the connector housing is fixed to an outer circumferential surface of the shield shell with a fixing ring. The grommet covers outer circumferential surfaces of the braided wire and the fixing ring as well as the shield shell.

### SUMMARY

In the above-described wire harness, there is a risk that the grommet may be damaged due to coming into contact with the fixing ring. As a measure against damage to the grommet, a configuration is conceivable in which an adhesive tape such as a butyl tape is wound around the outer circumferential surface of the fixing ring. However, in the configuration in which the fixing ring is covered with the adhesive tape, there is a risk of the fixing ring being exposed from the adhesive tape due to displacement of the adhesive tape over time, and consequently, the fixing ring may come into contact with the grommet.

An exemplary aspect of the disclosure provides a wire harness that can suppress damage to a grommet caused by contact with a fixing ring.

A wire harness according to the present disclosure is a wire harness including: a tubular shield shell that covers an outer circumferential surface of a connector housing; a tubular braided wire that covers an outer circumferential surface of an electric wire extending from the connector housing; a fixing ring that fixes the braided wire to an outer circumferential surface of the shield shell; and a tubular grommet that covers the shield shell, the braided wire, and the fixing ring, the wire harness further including a protective tube that is formed of a flexible material and covers an outer circumferential surface of the fixing ring inside the grommet, wherein the fixing ring includes a ring body that surrounds the outer circumferential surface of the shield shell, and a protruding portion protruding radially outward from the ring body, and the protective tube has a through hole that extends through a peripheral wall of the protective tube in a radial direction and into which the protruding portion is inserted.

The wire harness according to the present disclosure can suppress damage to the grommet caused by contact with the fixing ring.

### BRIEF DESCRIPTION OF THE DRAWINGS

FIG. 1 is a side view showing a part of a wire harness according to an embodiment;

FIG. 2 is a side view showing a state in which a grommet is removed from the wire harness according to the embodiment;

FIG. 3 is a partial cross-sectional view showing a part of the wire harness according to the embodiment;

FIG. 4 is a partial cross-sectional view showing a part of the wire harness according to the embodiment;

FIG. 5 is a cross-sectional view taken along a line 5 -5 in FIG. 4; and

FIG. 6 is a perspective view showing a protective tube prior to being attached in the embodiment.

### EMBODIMENTS OF THE DISCLOSURE

### Description of Embodiments of Present Disclosure

First, embodiments of the present disclosure are listed and described.
[1] A wire harness according to the present disclosure is a wire harness including: a tubular shield shell that covers an outer circumferential surface of a connector housing; a tubular braided wire that covers an outer circumferential surface of an electric wire extending from the connector housing; a fixing ring that fixes the braided wire to an outer circumferential surface of the shield shell; and a tubular grommet that covers the shield shell, the braided wire, and the fixing ring, the wire harness further including a protective tube that is formed of a flexible material and covers an outer circumferential surface of the fixing ring inside the grommet, wherein the fixing ring includes a ring body that surrounds the outer circumferential surface of the shield shell, and a protruding portion protruding radially outward from the ring body, and the protective tube has a through hole that extends through a peripheral wall of the protective tube in a radial direction and into which the protruding portion is inserted.

According to this configuration, the outer circumferential surface of the fixing ring is covered with the protective tube, thus making it possible to suppress damage to the grommet caused by contact with the fixing ring. Moreover, displacement of the protective tube can be suppressed because the protruding portion of the fixing ring is inserted into the through hole of the protective tube. As a result, an effect of protecting the grommet by the protective tube can be obtained effectively.
[2] In [1] above, the protective tube may include a lock protrusion that protrudes from an inner circumferential surface of the protective tube and can be locked to an axial end portion of the ring body.

According to this configuration, the protective tube includes the lock protrusion that protrudes from the inner circumferential surface of the protective tube and can be locked to the axial end portion of the ring body. Displacement of the protective tube can be further suppressed due to the lock protrusion of the protective tube being locked to the axial end portion of the ring body.
[3] In [1] or [2] above, the fixing ring may be a crimp ring that includes a crimped protrusion as the protruding portion and fastens and fixes the braided wire to the outer circumferential surface of the shield shell with the crimped protrusion crimped, and the crimped protrusion may be inserted into the through hole.

According to this configuration, the fixing ring is a crimp ring that includes the crimped protrusion as the protruding portion and fastens and fixes the braided wire to the outer circumferential surface of the shield shell with the crimped protrusion crimped. The crimped protrusion of the crimp ring is inserted into the through hole of the protective tube. Accordingly, it is possible to suppress displacement of the protective tube using the crimped protrusion necessary to fix the crimp ring, without adding any additional configuration to the crimp ring.
[4] In any one of [1] to [3] above, the through hole may be formed by widening a slit formed in the peripheral wall of the protective tube.

According to this configuration, the through hole is formed by widening the slit formed in the peripheral wall of the protective tube. Accordingly, the protruding portion of the fixing ring is inserted while widening the slit in the protective tube. Here, the through hole of the protective tube attempts to return to its natural state (the state in which the slit is closed), and accordingly, the protruding portion of the fixing ring and the through hole come into closer contact with each other. As a result, displacement of the protective tube can be more effectively suppressed.

### Details of Embodiment of Present Disclosure

A specific example of the present disclosure will be described below with reference to the drawings. In the drawings, a part of a configuration may be exaggerated or simplified for convenience of description. In addition, dimensional proportions of respective portions may be different between the drawings. The term “tubular” as used in this specification means not only a shape formed by a peripheral wall that is continuous over the entire circumference in the circumferential direction, but also a tubular shape formed by combining a plurality of components, and a shape having a notch or the like in a part in the circumferential direction, such as a C-shape. “Tubular” peripheral shapes include, but are not limited to, a circular shape, an elliptical shape, and polygonal shapes with pointed or round corners. “Tubular” shapes have through holes in a plan view, and include shapes having a through hole whose inner circumferential shape is the same as the peripheral shape and shapes having a through hole whose inner circumferential shape is different from the peripheral shape. “Tubular” shapes include shapes having a certain length in an axial direction along which a central axis passing through the center of a through hole extends, and there is no limitation on the length. Also, the terms “first”, “second”, etc., as used in this specification are used merely for distinguishing objects from each other, and do not indicate an order of the objects. The present disclosure is not limited to the examples disclosed herein, but is indicated by the claims, and is intended to encompass all modifications within the scope and meanings equivalent to the claims.

### Overall Configuration of Wire Harness 10

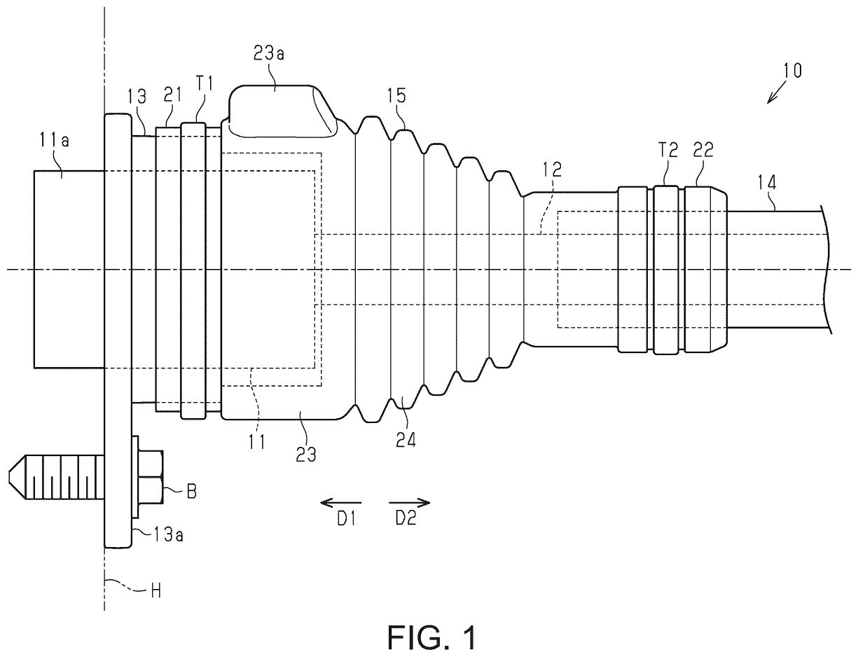

A wire harness 10 shown in FIG. 1 is installed in a vehicle V such as a hybrid vehicle or an electric vehicle, for example. The wire harness 10 electrically connects in-vehicle devices to each other. Examples of the in-vehicle devices electrically connected by the wire harness 10 include a high-voltage battery, an inverter, a motor, and the like.

As shown in FIG. 1, the wire harness 10 includes a connector housing 11, an electric wire 12, a shield shell 13, an exterior member 14, and a grommet 15. The connector housing 11, the shield shell 13, and the grommet 15 are provided at an end portion in the length direction of the wire harness 10.

The connector housing 11 accommodates a terminal (not shown) that is electrically connected to the electric wire 12. The electric wire 12 connected to the terminal in the connector housing 11 is drawn out from the connector housing 11. The exterior member 14 covers an outer circumferential surface of the electric wire 12 extending from the connector housing 11. The exterior member 14 is, for example, a corrugated tube.

### Configuration of Shield Shell 13

The shield shell 13 has a tubular shape covering an outer circumferential surface of the connector housing 11. The shield shell 13 is formed of an electrically conductive material such as metal. The shield shell 13 includes a fixing portion 13a that is fixed to a casing H of an in-vehicle device with a bolt B, for example. A base end side portion of the connector housing 11 is accommodated in the shield shell 13, and the connector housing 11 includes a leading end side fitting portion 11a protruding from the shield shell 13 to the outside. The fitting portion 11a is connected to a mating connector (not shown) provided in the casing H of the in-vehicle device. The shield shell 13 is attached to the casing H in a first direction D1 extending along the length direction of the wire harness 10. In the following description, the direction opposite to the first direction D1 will be referred to as a second direction D2.

### Configuration of Grommet 15

The grommet 15 is formed into a tubular shape using a flexible material having flexibility such as rubber or an elastomer. The grommet 15 includes a first fixed portion 21 that is fixed to the shield shell 13 and a second fixed portion 22 that is fixed to the exterior member 14. The first fixed portion 21 is provided at an end portion in the first direction D1 of the grommet 15. The first fixed portion 21 is fixed in a liquid-tight manner to an outer circumferential surface of the shield shell 13 using, for example, a first fixing member T1 constituted by a binding band or the like. The second fixed portion 22 is provided at an end portion in the second direction D2 of the grommet 15. The second fixed portion 22 is fixed in a liquid-tight manner to an outer circumferential surface of the exterior member 14 using, for example, a second fixing member T2 constituted by a binding band or the like.

The grommet 15 includes an accommodating portion 23 and a bellows portion 24 between the first fixed portion 21 and the second fixed portion 22. A crimp ring 40 fixed to the shield shell 13, which will be described later, is accommodated inside the accommodating portion 23. The bellows portion 24 is formed such that the outer diameter decreases from the accommodating portion 23 to the second fixed portion 22. The entire region of the grommet 15 from the first fixed portion 21 to the second fixed portion 22 has a tubular shape.

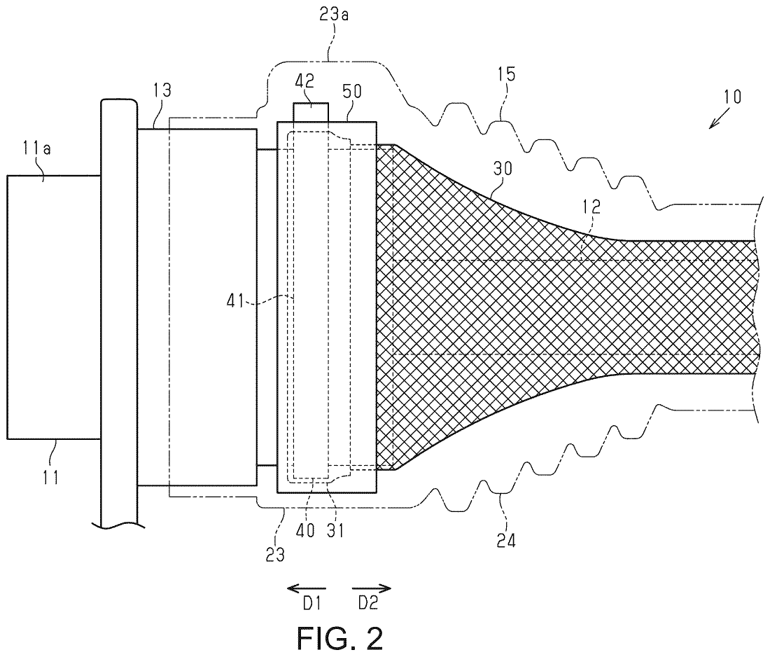

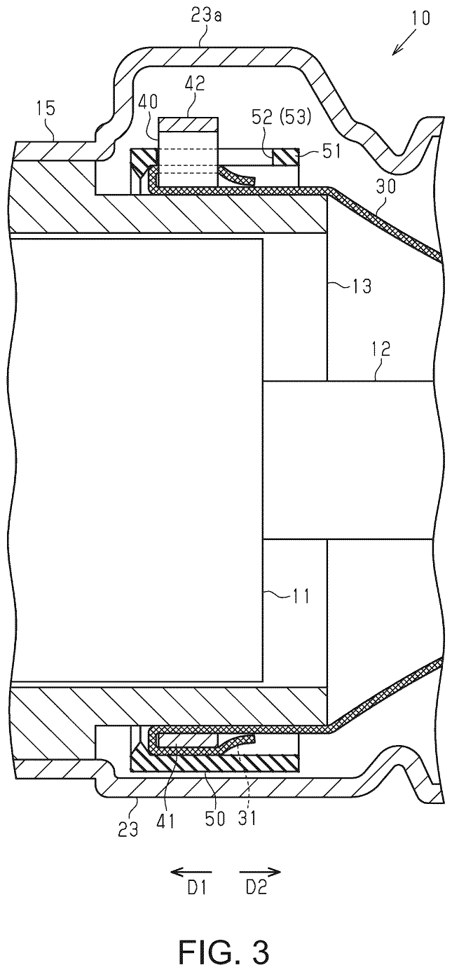

As shown in FIGS. 2 and 3, the wire harness 10 includes a tubular braided wire 30 that covers the outer circumferential surface of the electric wire 12 extending from the connector housing 11, and the crimp ring 40 that fixes the braided wire 30 to the outer circumferential surface of the shield shell 13. The wire harness 10 also includes a protective tube 50 that covers an outer circumferential surface of the crimp ring 40 inside the accommodating portion 23 of the grommet 15. The grommet 15 covers a portion of the shield shell 13, the crimp ring 40, the protective tube 50, and a portion of the braided wire 30.

### Configuration of Braided Wire 30

The braided wire 30 is obtained by braiding a plurality of metal strands into a tubular shape, for example. As the material of the braided wire 30, i.e., as the material of the metal strands, a copper-based metal material can be used, for example. The metal strands constituting the braided wire 30 may be plated with a copper-tin alloy. The electric wire 12 is passed through the braided wire 30. The exterior member 14 described above covers an outer circumferential surface of the braided wire 30. The electric wire 12 and the braided wire 30 extend from an end portion in the first direction D1 of the exterior member 14 to the outside of the exterior member 14. An end portion in the first direction D1 of the braided wire 30 has an increased diameter to cover the outer circumferential surface of an end portion in the second direction D2 of the shield shell 13, and the portion of the braided wire 30 covering the shield shell 13 is fixed by the crimp ring 40. The grommet 15 covers the outer circumferential surface of the portion of the braided wire 30 extending from the end portion in the first direction D1 of the exterior member 14.

### Configuration of Crimp Ring 40

The crimp ring 40 includes a ring body 41 that surrounds the outer circumferential surface of the shield shell 13, and a crimped protrusion 42 protruding radially outward from the ring body 41. The crimped protrusion 42 of the crimp ring 40 is crimped in a state where the braided wire 30 is between the ring body 41 and the outer circumferential surface of the shield shell 13 to fasten and fix the braided wire 30 to the outer circumferential surface of the shield shell 13.

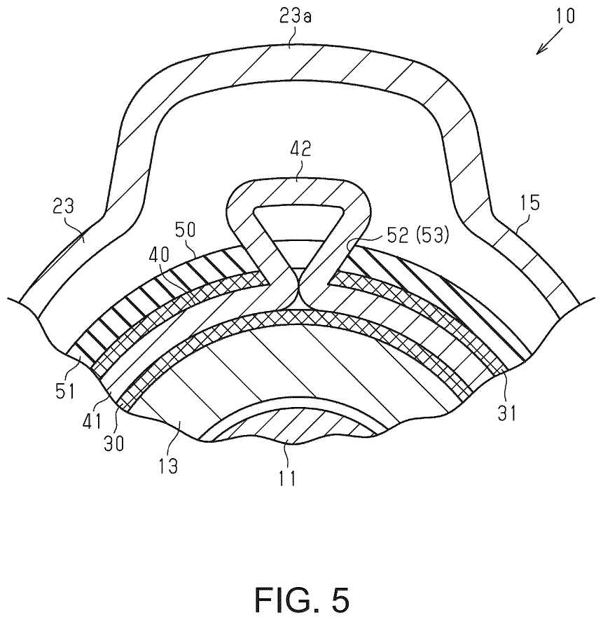

FIG. 5 is a partial transverse cross-sectional view showing a portion of the crimp ring 40 including the crimped protrusion 42 in an enlarged scale. As shown in FIG. 5, as viewed in the first direction D1, the crimped protrusion 42 becomes wider in the circumferential direction while extending outward in the radial direction of the crimp ring 40, for example. That is to say, as a result of a base end portion of the crimped protrusion 42 being crimped and deformed inward in the circumferential direction, the diameter of the ring body 41 decreases, and thus the braided wire 30 is fastened and fixed between an inner circumferential surface of the ring body 41 and the outer circumferential surface of the shield shell 13. The accommodating portion 23 of the grommet 15 includes a bulging portion 23a that bulges radially outward at a position corresponding to the crimped protrusion 42. The crimped protrusion 42 is disposed in the bulging portion 23a.

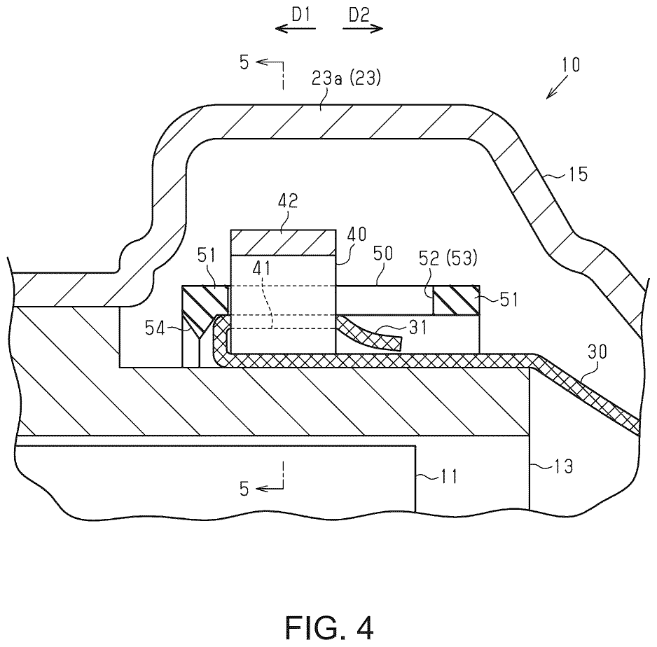

As shown in FIGS. 3 and 4, the braided wire 30 includes a folded-back portion 31 at the end portion in the first direction D1, for example. The folded-back portion 31 is formed by folding back, in the second direction D2, the end portion of the braided wire 30 extending from the position at which the braided wire 30 is fixed by the crimp ring 40. The folded-back portion 31 covers an outer circumferential surface of the ring body 41. The crimped protrusion 42 extends through the folded-back portion 31 and protrudes to the outer circumferential surface side of the folded-back portion 31. That is to say, the folded-back portion 31 covers the outer circumferential surface of the crimp ring 40 except for the crimped protrusion 42.

### Configuration of Protective Tube 50

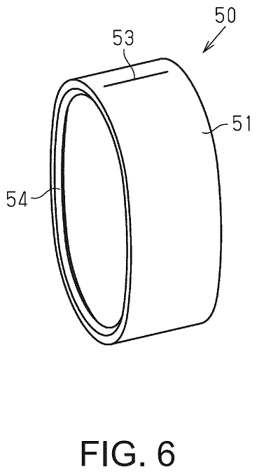

The protective tube 50 is formed of a flexible material such as rubber or an elastomer. The protective tube 50 includes a peripheral wall 51 that is formed into a tubular shape through injection molding, for example, and a through hole 52 that extends through the peripheral wall 51 in a radial direction. The crimped protrusion 42 of the crimp ring 40 is inserted into the through hole 52. Since the peripheral wall 51 is formed of a flexible material such as rubber or an elastomer, the peripheral wall 51 is elastic. The through hole 52 is formed by, for example, widening a slit 53 (see FIG. 6) that is formed in the peripheral wall 51 along the axial direction. The crimped protrusion 42 of the crimp ring 40 is inserted while widening the slit 53. Thus, the crimped protrusion 42 is inserted into the through hole 52.

The peripheral wall 51 of the protective tube 50 covers the outer circumferential surface of the ring body 41 of the crimp ring 40 from above the folded-back portion 31. That is to say, the folded-back portion 31 is between an inner circumferential surface of the peripheral wall 51 and the outer circumferential surface of the ring body 41. The crimped protrusion 42 extends through the through hole 52 of the protective tube 50 and protrudes to the outer circumferential surface side of the peripheral wall 51. That is to say, the peripheral wall 51 of the protective tube 50 covers the outer circumferential surface of the crimp ring 40 except for the crimped protrusion 42.

### Configuration of Lock Protrusion 54 in Protective Tube 50

As shown in FIGS. 4 and 6, the protective tube 50 includes a lock protrusion 54 protruding from the inner circumferential surface of the peripheral wall 51. The lock protrusion 54 is provided on the inner circumferential surface at an axial end portion (end portion in the first direction D1 in the present embodiment) of the peripheral wall 51, for example. The lock protrusion 54 is provided over the entire circumference of the inner circumferential surface of the peripheral wall 51, for example. The lock protrusion 54 can be locked to an axial end portion (end portion in the first direction D1 in the present embodiment) of the ring body 41 via the braided wire 30. Movement of the protective tube 50 in the second direction D2 is also restricted due to the lock protrusion 54 being locked to the end portion in the first direction D1 of the ring body 41.

### Functions of Present Embodiment

Functions of the present embodiment will be described below.

The crimped protrusion 42 of the crimp ring 40 is inserted into the through hole 52 of the protective tube 50. Accordingly, the through hole 52 engages with the crimped protrusion 42 and restricts movement of the protective tube 50 in the axial direction (the first direction D1 or the second direction D2) and the circumferential direction. With this configuration, it is possible to suppress displacement of the protective tube 50 in the axial direction and the circumferential direction. Furthermore, in the present embodiment, the lock protrusion 54 of the protective tube 50 can be locked to the end portion in the first direction D1 of the ring body 41, and therefore, displacement of the protective tube 50 in the second direction D2 can be further suppressed.

### Effects of Present Embodiment

Effects of the present embodiment will be described below.
(1) The wire harness 10 includes the protective tube 50 that covers the outer circumferential surface of the crimp ring 40 inside the grommet 15. The protective tube 50 has the through hole 52 that extends through the peripheral wall 51 of the protective tube 50 in the radial direction and into which the crimped protrusion 42 of the crimp ring 40 is inserted. According to this configuration, the outer circumferential surface of the crimp ring 40 is covered with the protective tube 50, thus making it possible to suppress damage to the grommet 15 caused by contact with the crimp ring 40. Moreover, since the crimped protrusion 42 of the crimp ring 40 is inserted into the through hole 52 of the protective tube 50, displacement of the protective tube 50 can be suppressed. As a result, the effect of protecting the grommet 15 by the protective tube 50 can be obtained effectively.
(2) The protective tube 50 includes the lock protrusion 54 that protrudes from the inner circumferential surface of the protective tube 50 and can be locked to the axial end portion of the ring body 41. Due to the lock protrusion 54 of the protective tube 50 being locked to the axial end portion of the ring body 41, displacement of the protective tube 50 can be further suppressed.
(3) The crimp ring 40 serving as a fixing ring for fixing the braided wire 30 to the outer circumferential surface of the shield shell 13 includes the crimped protrusion 42 as a protruding portion (protrusion) protruding radially outward from the ring body 41. The braided wire 30 is fastened and fixed to the outer circumferential surface of the shield shell 13 by crimping the crimped protrusion 42 of the crimp ring 40. The crimped protrusion 42 is inserted into the through hole 52 of the protective tube 50. According to this configuration, by inserting the crimped protrusion 42 into the through hole 52, it is possible to suppress displacement of the protective tube 50 using the crimped protrusion 42 necessary to fix the crimp ring 40, without adding any additional configuration to the crimp ring 40.
(4) The through hole 52 is formed by widening the slit 53 formed in the peripheral wall 51 of the protective tube 50. Accordingly, the crimped protrusion 42 of the crimp ring 40 is inserted while widening the slit 53 of the protective tube 50. Here, the through hole 52 of the protective tube 50 attempts to return to its natural state (the state in which the slit 53 is closed), and accordingly, the crimped protrusion 42 of the crimp ring 40 and the through hole 52 come into closer contact with each other. As a result, displacement of the protective tube 50 can be more effectively suppressed.

### Other Embodiments

The above embodiment can be implemented with the following modifications. The above embodiment and the following modification examples can be implemented in combination with each other as long as there is no technical contradiction.

The lock protrusion 54 of the protective tube 50 may be provided on the inner circumferential surface of an intermediate portion in the axial direction of the peripheral wall 51, for example.

The lock protrusion 54 of the protective tube 50 may be provided in a part in the circumferential direction of the peripheral wall 51, for example.

The protective tube 50 may not be provided with the lock protrusion 54.

The through hole 52 of the protective tube 50 may not be formed by widening the slit 53. For example, the through hole 52 may also be formed in advance in a hole shape having a predetermined opening area before the protective tube 50 is attached to the outer circumferential surface of the crimp ring 40.

Although the crimp ring 40 is used as the fixing ring for fixing the braided wire 30 to the outer circumferential surface of the shield shell 13 in the above embodiment, a hose clamp or the like can be used instead. That is to say, in the above embodiment, the crimped protrusion 42 of the crimp ring 40 is inserted into the through hole 52 of the protective tube 50, but the configuration of the protruding portion inserted into the through hole 52 can be changed as appropriate according to the configuration of the fixing ring.

The material of the protective tube 50 is not limited to the material in the above embodiment, and is only required to be a flexible material that does not damage the grommet 15.

The material of the grommet 15 is not limited to the material in the above embodiment, and can be changed as appropriate according to the configuration of the wire harness 10.

The braided wire 30 of the above embodiment may also be configured so as not to have the folded-back portion 31. In this case, the folded-back portion 31 is not interposed between the peripheral wall 51 of the protective tube 50 and the ring body 41, and the peripheral wall 51 and the ring body 41 are directly adjacent to each other.

The embodiments disclosed herein are illustrative in all aspects, and the present disclosure is not limited to these examples. That is to say, the scope of the present disclosure is indicated by the claims, and is intended to encompass all modifications within the scope and meanings equivalent to the claims.

What is claimed is:

1. A wire harness comprising:
a tubular shield shell that is configured to cover an outer circumferential surface of a connector housing;
a tubular braided wire that is configured to cover an outer circumferential surface of an electric wire extending from the connector housing;
a fixing ring that fixes the braided wire to an outer circumferential surface of the shield shell;
a tubular grommet that covers the shield shell, the braided wire, and the fixing ring; and
a protective tube that is formed of a flexible material and that covers an outer circumferential surface of the fixing ring inside the grommet, wherein:
the fixing ring includes a ring body that surrounds the outer circumferential surface of the shield shell, and a protrusion that protrudes radially outward from the ring body, and
the protective tube has a through hole that extends through a peripheral wall of the protective tube in a radial direction and into which the protrusion is inserted.

2. The wire harness according to claim 1,
wherein the protective tube includes a lock protrusion that protrudes from an inner circumferential surface of the protective tube and that can be locked to an axial end of the ring body.

3. The wire harness according to claim 1, wherein:
the fixing ring is a crimp ring that includes a crimped protrusion as the protrusion, and fastens and fixes the braided wire to the outer circumferential surface of the shield shell with the crimped protrusion crimped, and
the crimped protrusion is inserted into the through hole.

4. The wire harness according to claim 1,
wherein the through hole is formed by widening a slit formed in the peripheral wall of the protective tube.
